(19) United States
(12) Patent Application Publication
(10) Pub. No.: US 2021/0312824 A1
(43) Pub. Date: Oct. 7, 2021

(54) SMART PEN APPARATUS

(71) Applicant: MAGICOM INC., Alpharetta, GA (US)

(72) Inventor: Hongjun Song, Alpharetta, GA (US)

(21) Appl. No.: 17/220,062

(22) Filed: Apr. 1, 2021

Related U.S. Application Data
(60) Provisional application No. 63/003,554, filed on Apr. 1, 2020.

(51) Int. Cl. G09B 5/04; G06F 40/58; G06F 40/20; G06K 9/20; G10L 13/02; G09B 19/00

(52) U.S. Cl. CPC G09B 5/04; G06F 40/58; G06F 40/20; G06K 2209/01; G10L 13/02; G09B 19/00; G06K 9/20

(57) ABSTRACT

In one aspect, the present disclosure relates to a smart pen apparatus comprising: a pen tip module comprising: administration portion of a marking instrument, at least one light projection device, and an optical sensor configured to record markings; a pen body module comprising: an upper portion, a lower portion, a computing device comprising: an optical character recognition (OCR) capability, and a natural language processing (NLP) capability, wherein the computing device is in operative communication with the optical sensor, at least one audio output device, and a visual display, wherein the computing device is configured to receive and process the recorded markings, the at least one audio output device configured to produce an audio representation of the processed recorded markings, and the visual display; and a pen push button module comprising a charging port.

### RELATED APPLICATION

The present application claims benefit under the provisions of 35 U.S.C. § 119(e) of U.S. Provisional Application No. 63/003,554 filed on Apr. 1, 2020, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to smart pens.

### BACKGROUND

In some scenarios, for example, students meet unknown words, or do not know how to spell or pronounce the word properly. For another example, people may want to know how to translate a word into different languages. A typical way for solving these problems is to get help through a dictionary or online search. However, it is always time consuming and also very inconvenient. Therefore, there is a need for a simple way to phrase, spell, pronounce and translate words properly.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, the present disclosure relates to a smart pen apparatus comprising: a pen tip module comprising: administration portion of a marking instrument, at least one light projection device, and an optical sensor configured to record markings; a pen body module comprising: an upper portion, a lower portion, a computing device comprising: an optical character recognition (OCR) capability, and a natural language processing (NLP) capability, wherein the computing device is in operative communication with the optical sensor, at least one audio output device, and a visual display, wherein the computing device is configured to receive and process the recorded markings, the at least one audio output device configured to produce an audio representation of the processed recorded markings, and the visual display; and a pen push button module comprising a charging port.

In another aspect, the present disclosure relates to a method for playing back a plurality of markings from a smart pen apparatus, the method comprising: issuing a capture command, via a user input, of the smart pen apparatus, wherein issuing the capture command comprises activating an optical sensor of the smart pen apparatus; recording the plurality of markings via the optical sensor; transmitting the plurality of marking to a computing device, the computing device being housed in a pen body portion of the smart pen apparatus; performing a first process of optical character recognition (OCR) on the recorded plurality of markings via the computing device; performing a second process of natural language processing (NLP) on the recorded plurality of markings via the computing device, the computing device being in operative communication with at least one audio output device; transmitting the processed recorded plurality of markings to the at least one audio output device; and producing, via the at least one audio output device, an audio representation of the processed recorded plurality of markings.

In another aspect, the present disclosure relates to a method for translating a plurality of markings from a smart pen apparatus, the method comprising: issuing a capture command, via a user input, of the smart pen apparatus, wherein issuing the capture command comprises activating an optical sensor of the smart pen apparatus; recording a plurality of markings via the optical sensor; transmitting the plurality of marking to a computing device, the computing device being housed in the smart pen apparatus; performing a first process of optical character recognition (OCR) on the recorded plurality of markings via the computing device; performing a second process of natural language processing (NLP) on the recorded plurality of markings via the computing device, the computing device being in operative communication with at least one audio output device; performing a third process of translating the recorded plurality of markings, via the computing device, from a first language to a second language; transmitting the processed recorded plurality of markings to a storage device; transmitting the processed recorded plurality of markings to the at least one audio output device; and producing, via the at least one audio output device, an audio representation of the processed recorded plurality of markings.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a side view of a smart pen apparatus 100;

FIG. 2 illustrates a side view of a smart pen apparatus 100;

FIG. 3 illustrates a side view of a smart pen apparatus 100;

FIG. 4 is a flow chart of a method for playing back a plurality of markings from a smart pen apparatus;

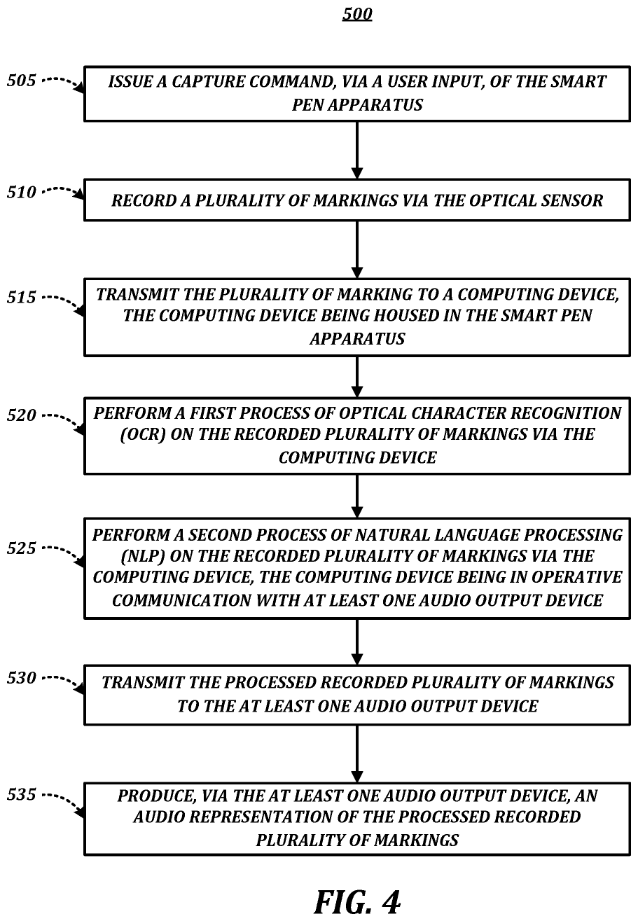

FIG. 5 is a flow chart of a method for translating a plurality of markings from a smart pen apparatus; and

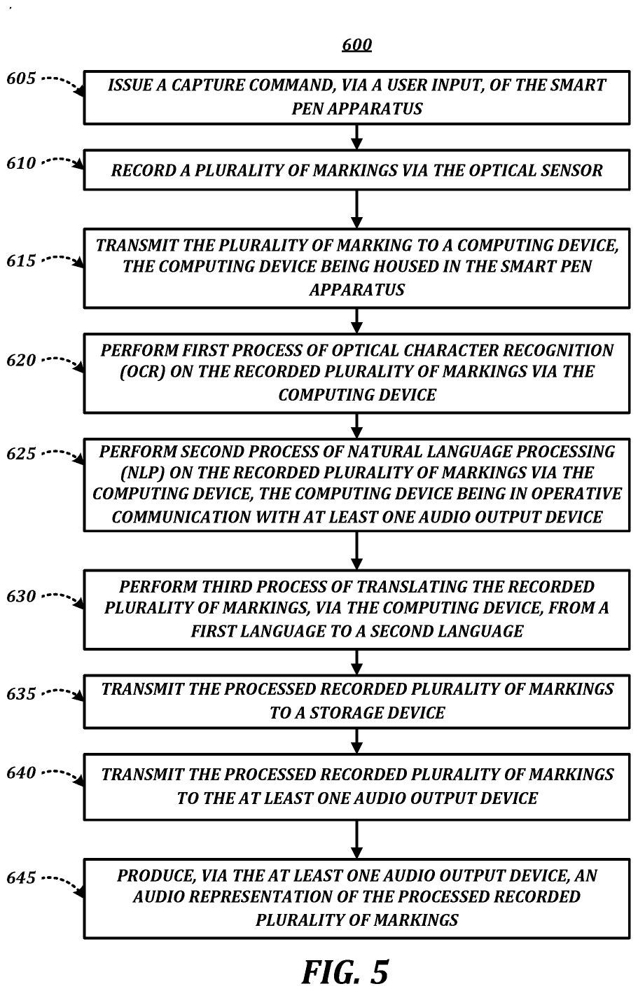

FIG. 6 is a block diagram of a system including a computing device 1000 for various methods and for smart pen apparatus 100.

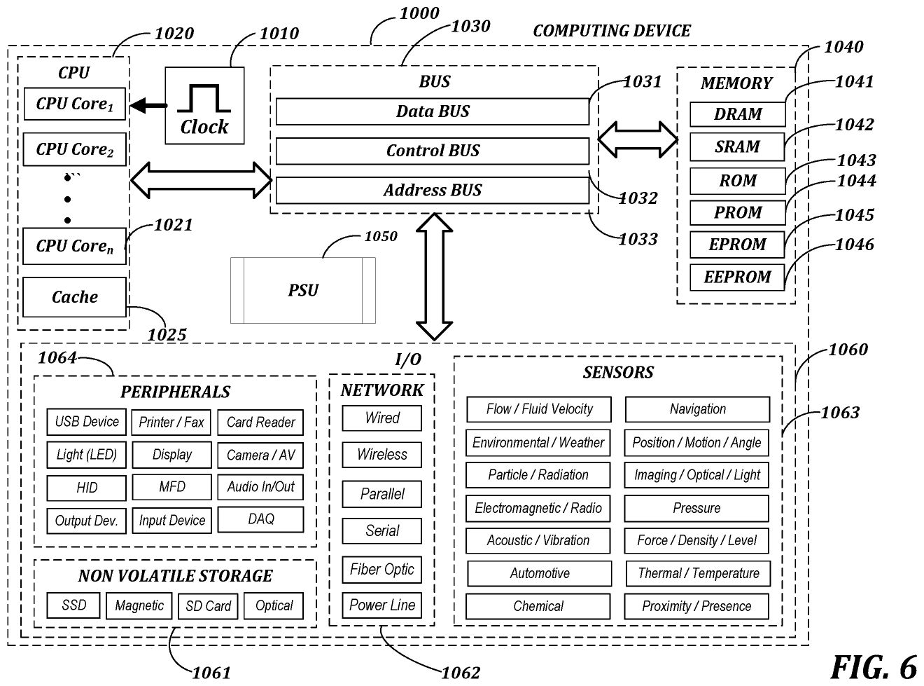

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of smart pens, embodiments of the present disclosure are not limited to use only in this context.

### I. Apparatus Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure, a smart pen apparatus, is a smart pen for education applications. The underlying principle of the device is based on leading edge technologies including Internet of Things (IoT), optical character recognition (OCR) and natural language processing (NLP).

The device may be comprised of, but not limited to, a pen body, pen tip, pen push button. The device may further comprise a pen. In some embodiments, the display screen may be located at an upper portion of the pen body. The device may further comprise at least one speaker. In some embodiments, at least one speaker may be located on both side of display screen.

The device may further comprise a processing unit, a communication module, and a memory storage, collectively referred to herein as a computing device. In some embodiments, the computing device may be placed within the pen body, under the display and speaker. The device may further comprise a charge/connection port. In some embodiments the charge/connection port may be located at the center of the pen push button for device charge and connection means.

Further still, the device may comprise at least one optical sensor. The optical sensor may be, for example, a camera. In some embodiments, the camera may be located near the pen tip to capture one or more images of handwriting or print words that are performed by a user of the device.

Still consistent with embodiments of the present disclosure, the device may comprise on or more lighting means. For example, in some embodiments, the device may comprise a plurality of lights that placed around the pen tip. The plurality of lights may be configured to illuminate the field of view captured by at least one optical sensor. In turn, the at least one optical sensor may be configured to better capture, for example, the handwriting or print words.

In accordance with embodiments of the present disclosure, the computing device may be configured to perform a plurality of functions. The computing device may be programmed to perform the functions within the apparatus of the present disclosure, and/or in conjunction with a remote computing device in data communication with the apparatus. The functions may be embodied within firmware and/or software and comprise OCR software. Such OCR software may be utilized to extract and recognize the characters being written by the user of the device. The characters may then be processed under NLP algorithms to parse and translate the recognized word into different languages. In turn, NLP algorithms may be used to generate synthetic voice, which will be pronounced through the speakers. In some embodiments, one or more of the software functions may be performed in real-time.

Accordingly, embodiments of the present disclosure may harness IoT, OCR, and NLP technologies to develop an innovative smart pen for education applications. Efforts are being pursued in terms of simulation-based optimization, prototype development, chip-to-world interfacing, and experimental testing and characterization. The prototype may be integrated with deep learning-based software to form a self-contained device capable of automated word recognition, pronunciation and translation.

In this way, the end product of the disclosed technology will be an integrated smart tool for education applications. The technology may find niche application in education field, especially early age education. Due to the high degree of adjustability, and integrability, the device will be suited for integration with a diversity of next-generation intelligent systems.

Embodiments of the present disclosure may comprise methods, systems, and a computer readable medium comprising, but not limited to, at least one of the following:

A. A Pen Tip Module;

B. A Pen Body Module;

C. A Pen Push Button Module; and

D. A Computing Device.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 1000 may be employed in the performance of some or all of the stages disclosed with regard to the methods. Similarly, an apparatus may be employed in the performance of some or all of the stages of the methods. As such, the apparatus may comprise at least those architectural components as found in computing device 1000.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. The method may comprise the following stages:

issuing a capture command, via a user input, of the smart pen apparatus,

wherein issuing the capture command comprises activating an optical sensor of the smart pen apparatus;

recording the plurality of markings via the optical sensor;

transmitting the plurality of marking to a computing device, the computing device being housed in a pen body portion of the smart pen apparatus;

performing a first process of optical character recognition (OCR) on the recorded plurality of markings via the computing device;

performing a second process of natural language processing (NLP) on the recorded plurality of markings via the computing device, the computing device being in operative communication with at least one audio output device;

transmitting the processed recorded plurality of markings to the at least one audio output device; and

producing, via the at least one audio output device, an audio representation of the processed recorded plurality of markings.

Although the aforementioned method has been described to be performed by the platform 100, it should be understood that computing device 1000 may be used to perform the various stages of the method. Furthermore, in some embodiments, different operations may be performed by different networked elements in operative communication with computing device 1000. For example, a plurality of computing devices may be employed in the performance of some or all of the stages in the aforementioned method. Moreover, a plurality of computing devices may be configured much like a single computing device 1000. Similarly, an apparatus may be employed in the performance of some or all stages in the method. The apparatus may also be configured much like computing device 1000.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Apparatus Configuration

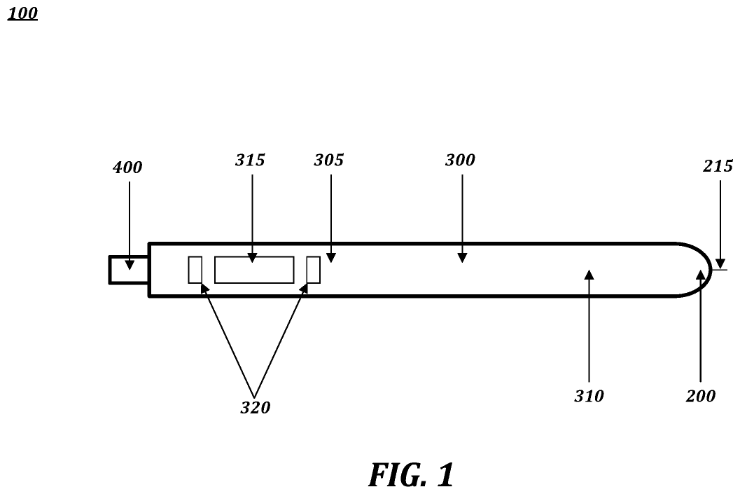

FIG. 1 illustrates one possible operating environment through which a platform consistent with embodiments of the present disclosure may be provided. By way of non-limiting example, various components of apparatus 100 may be hosted on, for example, a cloud computing service. In some embodiments, the platform 100 may be hosted on a computing device 1000. A user may access platform 100 through a software application and/or hardware device. The software application may be embodied as, for example, but not be limited to, a website, a web application, a desktop application, and a mobile application compatible with the computing device 1000. One possible embodiment of the software application and/or hardware device may be provided by the Magicom™ suite of products and services provided by Magicom Inc.

FIG. 1 illustrates one possible operating environment through which a platform consistent with embodiments of the present disclosure may be provided. By way of non-limiting example, various components of apparatus 100 and/or methods may be hosted in both a blockchain protocol (“on-chain”) and off of a blockchain protocol (“off-chain”). One possible embodiment of the platform may be provided by the Magicom™ protocol provided by Magicom Inc. It should be understood that layers and stages performed by the layers may be either “on-chain” or “off-chain”. The present disclosure anticipates embodiments with variations as to which stages may be performed “on-chain” or “off-chain”.

Accordingly, embodiments of the present disclosure provide a software and hardware platform comprised of a distributed set of computing elements, including, but not limited to:

A. Pen Tip Module

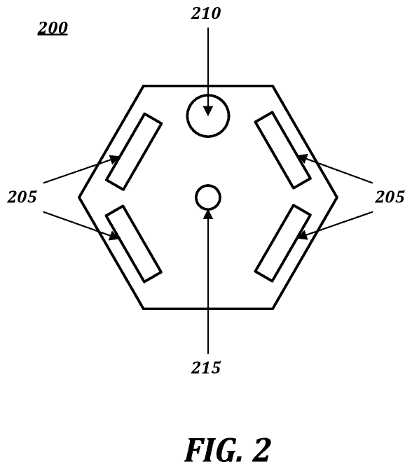

FIG. 2 illustrates pen tip module 200 in accordance with embodiments of the present disclosure. In some embodiments, pen tip module may comprise at least one light projection device 205. At least one light projection device 205 may be embodied as, for example, at least one of the following:

1. a reflective device,

2. a light emitting diode (LED),

3. a compact fluorescent lamp (CFL),

4. an incandescent bulb,

5. a fluorescent bulb,

6. a halogen bulb, and

7. any other light bulb.

In further embodiments, pen tip module 200 may comprise one least one optical sensor 210. At least one optical sensor 210 may be embodied as, for example, a camera. At least one optical sensor 210 may be configured to record at least one of the following:

1. a marking,

2. a graphical representation,

3. a text,

4. a handwriting, and

5. any other type of visually represented material.

In yet further embodiments, pen tip module 200 may connect to a pen body module 300.

In yet further embodiments, pen tip module 200 may be configured to house and/or guide an administration portion 215 of a writing and/or marking instrument.

B. Pen Body Module

FIG. 1 illustrates pen body module 300 in accordance with embodiments of the present disclosure. In some embodiments, pen body module 300 may comprise an upper portion 305. Upper portion 305 may be embodied as, for example, the upper half of pen body module 300 configured to connect to and/or house a pen push button module 400. In further embodiments, pen body module 300 may comprise a lower portion 310. Lower portion 310 may be embodied as, for example, the lower half of pen body module 300 configured to connect to and/or house pen tip module 200.

In some embodiments, pen body module 300 may comprise a computing device 1000. In some embodiments, computing device 1000, may comprise an optical character recognition (OCR) capability and/or algorithm. In some embodiments, computing device 1000, may comprise a natural language processing (NLP) capability and/or algorithm. The NLP capability and/or algorithm may be used for translation and/or voice synthesis. In some embodiments, computing device 1000, may be configured to process data recorded from optical sensor 210.

In some embodiments, pen body module 300 may comprise at least one visual display 315. In some embodiments, at least one visual display 315 may be located on upper portion 305 of the pen body. In some embodiments, at least one visual display 315 may be in operative communication with computing device 1000. In further embodiments, at least one visual display 315 may comprise a playback command. The playback command may be used to instruct an at least one audio output device 320 to output audio of the processed markings.

In further embodiments, pen body module 300 may comprise at least one audio output device 320. In some embodiments, at least one at least one audio output device 320 may be in operative communication with computing device 1000.

By way of nonlimiting example, in some embodiments, visual display 315 is located on the upper portion of pen body module 300 and two audio output devices 320 are located on either side of visual display 315.

In further embodiments, pen body module 300 may be configured to house the writing and/or marking instrument. The writing and/or marking instrument may be embodied as, for example, an ink cartridge. In some embodiments, the writing and/or marking instrument may be interchangeable.

C. Pen Push Button Module

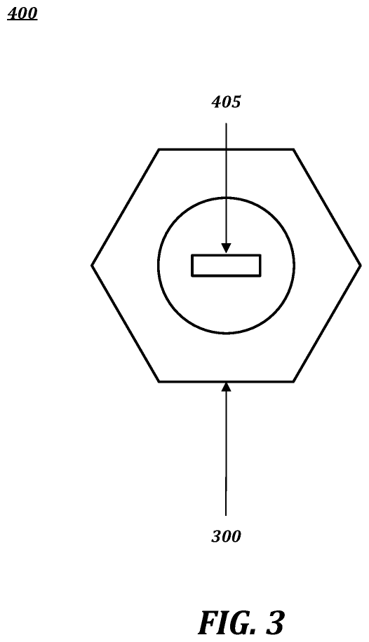

FIG. 3 illustrates pen push button module 400 in accordance with embodiments of the present disclosure.

In some embodiments, pen push button module 400 may comprise a charging/connection port 405. In some embodiments, charging/connection port 405 may be used to power, charge, and/or recharge smart pen apparatus 100. In further embodiments, pen push button module 400 may connect to pen tip module 200.

In further embodiments, pen push button module 400 may be configured to connect to and/or be housed in, pen body module 300.

In yet further embodiments, pen push button module 400 may connect to and/or house a portion of the writing and/or marking instrument.

D. Computing Device

Computing device 1000 may be provided. In some embodiments, pen body module 300 may house computing device 1000.

### III. Platform Operation

Embodiments of the present disclosure provide an apparatus, hardware, and a software platform operative, at least in part, by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 1000 may be employed in the performance of some or all of the stages disclosed with regard to the methods. Similarly, an apparatus may be employed in the performance of some or all of the stages of the methods. As such, the apparatus may comprise at least those architectural components as found in computing device 1000.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Consistent with embodiments of the present disclosure, a method may be performed by at least one of the aforementioned modules. The following depicts an example of a plurality of methods that may be performed by at least one of the aforementioned modules. Various components may be used at the various stages of operations disclosed with reference to each module. The plurality of methods may be embodied as, for example, but not limited to, computer instructions, which when executed, perform the plurality of methods. The plurality of methods may comprise the following stages:

A. Method for Playing Back a Plurality of Markings from a Smart Pen Apparatus

Method 500
(Variation) providing a visual display on the upper portion of the pen body portion;
Step 505—issuing a capture command, via a user input, of the smart pen apparatus,
   (Variation) receiving the user input via the visual display,
   wherein issuing the capture command comprises activating an optical sensor of the smart pen apparatus;
Step 510—recording a plurality of markings via the optical sensor,
   (Variation) providing a pen tip module connected to the lower portion of the pen body module;
      providing an at least one light projection device on the pen tip module,
      using the at least one light projection device to assist in the recording of the plurality of markings;
   (Variation) housing a marking instrument in the smart pen apparatus,
      recording the plurality of markings via the optical sensor comprises recording the actions of an administration portion of a marking instrument;
Step 515—transmitting the plurality of marking to a computing device, the computing device being housed in the smart pen apparatus,
   (Variation), the computing device being housed in the body portion of the smart pen apparatus;
Step 520—performing a first process of optical character recognition (OCR) on the recorded plurality of markings via the computing device;
Step 525—performing a second process of natural language processing (NLP) on the recorded plurality of markings via the computing device, the computing device being in operative communication with at least one audio output device;
(Variation) performing a third process of translating the recorded plurality of markings, via the computing device, from a first language to a second language;
(Variation) transmitting the processed recorded plurality of markings to a storage device;
Step 530—transmitting the processed recorded plurality of markings to the at least one audio output device;
Step 535—producing, via the at least one audio output device, an audio representation of the processed recorded plurality of markings; and
(Variation) housing a charging outlet in a pen push button module of the smart pen apparatus.

B. Method for Translating a Plurality of Markings from a Smart Pen Apparatus

Method 600
Step 605—issuing a capture command, via a user input, of the smart pen apparatus,
   wherein issuing the capture command comprises activating an optical sensor of the smart pen apparatus;
Step 615—recording a plurality of markings via the optical sensor;
Step 620—transmitting the plurality of marking to a computing device, the computing device being housed in the smart pen apparatus;
Step 625—performing a first process of optical character recognition (OCR) on the recorded plurality of markings via the computing device;
Step 630—performing a second process of natural language processing (NLP) on the recorded plurality of markings via the computing device, the computing device being in operative communication with at least one audio output device;
Step 635—performing a third process of translating the recorded plurality of markings, via the computing device, from a first language to a second language;
Step 640—transmitting the processed recorded plurality of markings to a storage device;
Step 645—transmitting the processed recorded plurality of markings to the at least one audio output device; and
Step 650—producing, via the at least one audio output device, an audio representation of the processed recorded plurality of markings.

### IV. Computing Device Architecture

Embodiments of the present disclosure provide a hardware and software platform operative as a distributed system of modules and computing elements.

Portions of apparatus 100 may be embodied as, for example, but not be limited to, a website, a web application, a desktop application, backend application, and a mobile application compatible with a computing device 1000. The computing device 1000 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series; and

A microcomputer, wherein the microcomputer computing device comprises, but is not limited to, a server, wherein a server may be rack mounted, a workstation, an industrial device, a raspberry pi, a desktop, or an embedded device.

Portions of apparatus 100 may be hosted on a centralized server or a cloud computing service. Although methods 500 and 600 have been described to be performed by a computing device 1000, it should be understood that, in some embodiments, different operations may be performed by a plurality of the computing devices 1000 in operative communication at least one network.

Embodiments of the present disclosure may comprise a system having a central processing unit (CPU) 1020, a bus 1030, a memory unit 1040, a power supply unit (PSU) 1050, and one or more Input/Output (I/O) units. The CPU 1020 coupled to the memory unit 1040 and the plurality of I/O units 1060 via the bus 1030, all of which are powered by the PSU 1050. It should be understood that, in some embodiments, each disclosed unit may actually be a plurality of such units for the purposes of redundancy, high availability, and/or performance. The combination of the presently disclosed units is configured to perform the stages any method disclosed herein.

FIG. * is a block diagram of a system including computing device 1000. Consistent with an embodiment of the disclosure, the aforementioned CPU 1020, the bus 1030, the memory unit 1040, a PSU 1050, and the plurality of I/O units 1060 may be implemented in a computing device, such as computing device 1000 of FIG. *. Any suitable combination of hardware, software, or firmware may be used to implement the aforementioned units. For example, the CPU 1020, the bus 1030, and the memory unit 1040 may be implemented with computing device 1000 or any of other computing devices 1000, in combination with computing device 1000. The aforementioned system, device, and components are examples and other systems, devices, and components may comprise the aforementioned CPU 1020, the bus 1030, the memory unit 1040, consistent with embodiments of the disclosure.

At least one computing device 1000 may be embodied as any of the computing elements illustrated in all of the attached figures, including pen tip module 200, pen body module 300, pen push button 400, the method for playing back a plurality of markings from a smart pen apparatus, and the method for translating a plurality of markings from a smart pen apparatus. A computing device 1000 does not need to be electronic, nor even have a CPU 1020, nor bus 1030, nor memory unit 1040. The definition of the computing device 1000 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 1000, especially if the processing is purposeful.

With reference to FIG.*, a system consistent with an embodiment of the disclosure may include a computing device, such as computing device 1000. In a basic configuration, computing device 1000 may include at least one clock module 1010, at least one CPU 1020, at least one bus 1030, and at least one memory unit 1040, at least one PSU 1050, and at least one I/O 1060 module, wherein I/O module may be comprised of, but not limited to a non-volatile storage sub-module 1061, a communication sub-module 1062, a sensors sub-module 1063, and a peripherals sub-module 1064.

A system consistent with an embodiment of the disclosure the computing device 1000 may include the clock module 1010 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling ata rate slower than the worst-case internal propagation delays. The preeminent example of the aforementioned integrated circuit is the CPU 1020, the central component of modern computers, which relies on a clock. The only exceptions are asynchronous circuits such as asynchronous CPUs. The clock 1010 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 1000 use a “clock multiplier” which multiplies a lower frequency external clock to the appropriate clock rate of the CPU 1020. This allows the CPU 1020 to operate at a much higher frequency than the rest of the computer, which affords performance gains in situations where the CPU 1020 does not need to wait on an external factor (like memory 1040 or input/output 1060). Some embodiments of the clock 1010 may include dynamic frequency change, where, the time between clock edges can vary widely from one edge to the next and back again.

A system consistent with an embodiment of the disclosure the computing device 1000 may include the CPU unit 1020 comprising at least one CPU Core 1021. A plurality of CPU cores 1021 may comprise identical CPU cores 1021, such as, but not limited to, homogeneous multi-core systems. It is also possible for the plurality of CPU cores 1021 to comprise different CPU cores 1021, such as, but not limited to, heterogeneous multi-core systems, big.LITTLE systems and some AMD accelerated processing units (APU). The CPU unit 1020 reads and executes program instructions which may be used across many application domains, for example, but not limited to, general purpose computing, embedded computing, network computing, digital signal processing (DSP), and graphics processing (GPU). The CPU unit 1020 may run multiple instructions on separate CPU cores 1021 at the same time. The CPU unit 1020 may be integrated into at least one of a single integrated circuit die and multiple dies in a single chip package. The single integrated circuit die and multiple dies in a single chip package may contain a plurality of other aspects of the computing device 1000, for example, but not limited to, the clock 1010, the CPU 1020, the bus 1030, the memory 1040, and I/O 1060.

The CPU unit 1020 may contain cache 1022 such as, but not limited to, a level 1 cache, level 2 cache, level 3 cache or combination thereof. The aforementioned cache 1022 may or may not be shared amongst a plurality of CPU cores 1021. The cache 1022 sharing comprises at least one of message passing and inter-core communication methods may be used for the at least one CPU Core 1021 to communicate with the cache 1022. The inter-core communication methods may comprise, but not limited to, bus, ring, two-dimensional mesh, and crossbar. The aforementioned CPU unit 1020 may employ symmetric multiprocessing (SMP) design.

The plurality of the aforementioned CPU cores 1021 may comprise soft microprocessor cores on a single field programmable gate array (FPGA), such as semiconductor intellectual property cores (IP Core). The plurality of CPU cores 1021 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 1021, for example, but not limited to Instruction-level parallelism (ILP) such as, but not limited to, superscalar pipelining, and Thread-level parallelism (TLP).

Consistent with the embodiments of the present disclosure, the aforementioned computing device 1000 may employ a communication system that transfers data between components inside the aforementioned computing device 1000, and/or the plurality of computing devices 1000. The aforementioned communication system will be known to a person having ordinary skill in the art as a bus 1030. The bus 1030 may embody internal and/or external plurality of hardware and software components, for example, but not limited to a wire, optical fiber, communication protocols, and any physical arrangement that provides the same logical function as a parallel electrical bus. The bus 1030 may comprise at least one of, but not limited to a parallel bus, wherein the parallel bus carry data words in parallel on multiple wires, and a serial bus, wherein the serial bus carry data in bit-serial form. The bus 1030 may embody a plurality of topologies, for example, but not limited to, a multidrop/electrical parallel topology, a daisy chain topology, and a connected by switched hubs, such as USB bus. The bus 1030 may comprise a plurality of embodiments, for example, but not limited to:
Internal data bus (data bus) 1031/Memory bus
Control bus 1032
Address bus 1033
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to,

Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 1000 may employ hardware integrated circuits that store information for immediate use in the computing device 1000, know to the person having ordinary skill in the art as primary storage or memory 1040. The memory 1040 operates at high speed, distinguishing it from the non-volatile storage sub-module 1061, which may be referred to as secondary or tertiary storage, which provides slow-to-access information but offers higher capacities at lower cost. The contents contained in memory 1040, may be transferred to secondary storage via techniques such as, but not limited to, virtual memory and swap. The memory 1040 may be associated with addressable semiconductor memory, such as integrated circuits consisting of silicon-based transistors, used for example as primary storage but also other purposes in the computing device 1000. The memory 1040 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 1041, Static Random-Access Memory (SRAM) 1042, CPU Cache memory 1025, Advanced Random-Access Memory (A-RAM), and other types of primary storage such as Random-Access Memory (RAM).
Non-volatile memory which can retain stored information even after power is removed, for example, but not limited to, Read-Only Memory (ROM) 1043, Programmable ROM (PROM) 1044, Erasable PROM (EPROM) 1045, Electrically Erasable PROM (EEPROM) 1046 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 1000 may employ the communication system between an information processing system, such as the computing device 1000, and the outside world, for example, but not limited to, human, environment, and another computing device 1000. The aforementioned communication system will be known to a person having ordinary skill in the art as I/O 1060. The I/O module 1060 regulates a plurality of inputs and outputs with regard to the computing device 1000, wherein the inputs are a plurality of signals and data received by the computing device 1000, and the outputs are the plurality of signals and data sent from the computing device 1000. The I/O module 1060 interfaces a plurality of hardware, such as, but not limited to, non-volatile storage 1061, communication devices 1062, sensors 1063, and peripherals 1064. The plurality of hardware is used by the at least one of, but not limited to, human, environment, and another computing device 1000 to communicate with the present computing device 1000. The I/O module 1060 may comprise a plurality of forms, for example, but not limited to channel I/O, port mapped I/O, asynchronous I/O, and Direct Memory Access (DMA).

Consistent with the embodiments of the present disclosure, the aforementioned computing device 1000 may employ the non-volatile storage sub-module 1061, which may be referred to by a person having ordinary skill in the art as one of secondary storage, external memory, tertiary storage, off-line storage, and auxiliary storage. The non-volatile storage sub-module 1061 may not be accessed directly by the CPU 1020 without using intermediate area in the memory 1040. The non-volatile storage sub-module 1061 does not lose data when power is removed and may be two orders of magnitude less costly than storage used in memory module, at the expense of speed and latency. The non-volatile storage sub-module 1061 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (1061) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 1000 may employ the communication sub-module 1062 as a subset of the I/O 1060, which may be referred to by a person having ordinary skill in the art as at least one of, but not limited to, computer network, data network, and network. The network allows computing devices 1000 to exchange data using connections, which may be known to a person having ordinary skill in the art as data links, between network nodes. The nodes comprise network computer devices 1000 that originate, route, and terminate data. The nodes are identified by network addresses and can include a plurality of hosts consistent with the embodiments of a computing device 1000. The aforementioned embodiments include, but not limited to personal computers, phones, servers, drones, and networking devices such as, but not limited to, hubs, switches, routers, modems, and firewalls.

Two nodes can be said are networked together, when one computing device 1000 is able to exchange information with the other computing device 1000, whether or not they have a direct connection with each other. The communication sub-module 1062 supports a plurality of applications and services, such as, but not limited to World Wide Web (WWW), digital video and audio, shared use of application and storage computing devices 1000, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 1062 may comprise a plurality of size, topology, traffic control mechanism and organizational intent. The communication sub-module 1062 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 1000 may employ the sensors sub-module 1063 as a subset of the I/O 1060. The sensors sub-module 1063 comprises at least one of the devices, modules, and subsystems whose purpose is to detect events or changes in its environment and send the information to the computing device 1000. Sensors are sensitive to the measured property, are not sensitive to any property not measured, but may be encountered in its application, and do not significantly influence the measured property. The sensors sub-module 1063 may comprise a plurality of digital devices and analog devices, wherein if an analog device is used, an Analog to Digital (A-to-D) converter must be employed to interface the said device with the computing device 1000. The sensors may be subject to a plurality of deviations that limit sensor accuracy. The sensors sub-module 1063 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 1000 may employ the peripherals sub-module 1062 as a subset of the I/O 1060. The peripheral sub-module 1064 comprises ancillary devices uses to put information into and get information out of the computing device 1000. There are 3 categories of devices comprising the peripheral sub-module 1064, which exist based on their relationship with the computing device 1000, input devices, output devices, and input/output devices. Input devices send at least one of data and instructions to the computing device 1000. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 1000. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 1064:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 1000. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 1000 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 1000. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g., devices disclosed in network 1062 sub-module), data storage device (non-volatile storage 1061), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Aspects

The following disclose various Aspects of the present disclosure. The various Aspects are not to be construed as patent claims unless the language of the Aspect appears as a patent claim. The Aspects describe various non-limiting embodiments of the present disclosure.
Aspect 1. In some embodiments, a circuit board and processor is placed under the screen and speakers. In yet further embodiments, a charge/connection port is located on the center of the pen push button for device charge and connection purpose.

In still further embodiments, the camera is located near the pen tip to capture the image of handwriting or print words.

In even further embodiments, four lights are placed around the pen tip for brightening the view field to help better capture the image.

In yet still further embodiments, innovative OCR software are utilized to real time extract and recognize the word characters, and NLP algorithms are utilized to parse and translate the recognized word into different languages in real time.

In even yet still further embodiments, NLP algorithms are also used to generate the real time synthetic voice, which will be pronounced through the speakers.

Advanced deep learning methods, for example, Bidirectional Encoder Representations from Transformers (BERT), may be used for training NLP models to translate and create synthetic voice in different languages.
Aspect 2. Embodiments of the present disclosure provide a hardware and software platform operative as a distributed system of modules and computing elements.

In the operation, the handwriting or printing words will be detected and recognized with OCR software.

Modern deep learning algorithms such as Efficient and Accurate Scene Text Detector (EAST) and Convolutional Recurrent Neural Network (CRNN) may be used for text detection and recognition.

Furthermore, the recognized texts are phrased and pronounced through the speaker using NLP software.

Advanced deep learning algorithms, such as BERT may be used for training a robust model for text translation and voice synthesis.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A smart pen apparatus comprising:
a pen tip module comprising:
an administration portion of a marking instrument,
at least one light projection device, and
an optical sensor configured to record a plurality of markings;
a pen body module comprising:
an upper portion,
a lower portion,
a computing device comprising:
an optical character recognition (OCR) capability, and
a natural language processing (NLP) capability,
wherein the computing device is in operative communication with the optical sensor, at least one audio output device, and a visual display,
wherein the computing device is configured to receive and process the recorded plurality of markings,
the at least one audio output device configured to produce an audio representation of the processed recorded plurality of markings, and
the visual display; and
a pen push button module comprising a charging port.

2. The apparatus of claim 1, wherein the pen body module is configured to house a marking instrument.

3. The apparatus of claim 2, wherein the optical sensor is configured to record markings made from the administration portion of the marking instrument.

4. The apparatus of claim 1, wherein the visual display is housed on the upper portion of the pen body module.

5. The apparatus of claim 1, wherein at least a portion of the pen push button module is configured to be housed in the upper portion of the pen body module.

6. The apparatus of claim 1, wherein at least a portion of the pen tip module is configured to connect to the lower portion of the pen body module.

7. The apparatus of claim 1, wherein the processing comprises performing OCR and NLP to the recorded plurality of markings.

8. The apparatus of claim 1, wherein the visual display comprises a playback command instructing the at least one audio output to play the audio representation of the processed recorded plurality of markings.

9. The apparatus of claim 1, wherein the NLP capability comprises a translation and voice synthesis capability.

10. A method for playing back a plurality of markings from a smart pen apparatus, the method comprising:
issuing a capture command, via a user input, of the smart pen apparatus,
wherein issuing the capture command comprises activating an optical sensor of the smart pen apparatus;
recording the plurality of markings via the optical sensor;
transmitting the plurality of marking to a computing device, the computing device being housed in a pen body portion of the smart pen apparatus;
performing a first process of optical character recognition (OCR) on the recorded plurality of markings via the computing device;
performing a second process of natural language processing (NLP) on the recorded plurality of markings via the computing device, the computing device being in operative communication with at least one audio output device;
transmitting the processed recorded plurality of markings to the at least one audio output device; and
producing, via the at least one audio output device, an audio representation of the processed recorded plurality of markings.

11. The method of claim 10, further comprising providing a visual display on the upper portion of the pen body portion.

12. The method of claim 11, further comprising receiving the user input via the visual display.

13. The method of claim 10, further comprising providing a pen tip module connected to the lower portion of the pen body module.

14. The method of claim 13, further comprising providing an at least one light projection device on the pen tip module.

15. The method of claim 14, further comprising using the at least one light projection device to assist in the recording of the plurality of markings.

16. The method of claim 10, further comprising housing a marking instrument in the smart pen apparatus.

17. The method of claim 16, wherein recording the plurality of markings via the optical sensor comprises recording the actions of an administration portion of a marking instrument.

18. The method of claim 10, further comprising housing a charging outlet in a pen push button module of the smart pen apparatus.

19. A method for translating a plurality of markings from a smart pen apparatus, the method comprising:
issuing a capture command, via a user input, of the smart pen apparatus,
wherein issuing the capture command comprises activating an optical sensor of the smart pen apparatus;
recording a plurality of markings via the optical sensor;
transmitting the plurality of marking to a computing device, the computing device being housed in the smart pen apparatus;
performing a first process of optical character recognition (OCR) on the recorded plurality of markings via the computing device;
performing a second process of natural language processing (NLP) on the recorded plurality of markings via the computing device, the computing device being in operative communication with at least one audio output device;
performing a third process of translating the recorded plurality of markings, via the computing device, from a first language to a second language;
transmitting the processed recorded plurality of markings to a storage device;
transmitting the processed recorded plurality of markings to the at least one audio output device; and
producing, via the at least one audio output device, an audio representation of the processed recorded plurality of markings.

20. The method of claim 19, wherein transmitting the processed recorded plurality of markings to a storage device comprises storing the processed recorded plurality of markings on at least one of the following:
a local storage device; and
a remote storage device.
